(19) United States
(12) Patent Application Publication
(10) Pub. No.: US 2025/0156384 A1
(43) Pub. Date: May 15, 2025

(54) MIGRATION PLATFORM FOR LEGACY DATABASE MIGRATION WITH A LARGE LANGUAGE MODEL

(71) Applicant: Peerislands Holdings LLC, Southlake, TX (US)

(72) Inventors: Rajesh Rajagopalan, Southlake, TX (US); Krishnakumar Sathyanarayana, Southlake, TX (US); Rajesh Vinayagam, Southlake, TX (US); Sureshkannan Muthusamy, Southlake, TX (US); Puviarasu Senthil, Southlake, TX (US); Naveen Muniyasamy, Southlake, TX (US); Madhu Ramaya, Southlake, TX (US)

(21) Appl. No.: 18/948,748

(22) Filed: Nov. 15, 2024

Related U.S. Application Data
(60) Provisional application No. 63/599,294, filed on Nov. 15, 2023.

(51) Int. Cl. G06F 16/21; H04L 51/02

(52) U.S. Cl. CPC G06F 16/214; H04L 51/02

(57) ABSTRACT

A method, apparatus, and computer-readable medium of a migration platform for analyzing a legacy database based on applying a large language model to the legacy database and legacy application code to extract legacy database values and legacy application values, determining destination database values corresponding to a destination database based on the legacy database values and the legacy application values, generating migration code for migrating the legacy database to the destination database based on code generation templates, user preferences, and code generation procedures configured to create one or more files and one or more directories based on the code generation templates, validating the migration code based on generating mock data, storing the mock data in the legacy database, and applying the migration code to the mock data to migrate the mock data to the destination database, and executing the validated migration code to perform a migration of the legacy database.

### RELATED APPLICATION DATA

This application claims priority to U.S. Provisional Application No. 63/599,294, filed Nov. 15, 2023, the disclosure of which is hereby incorporated by reference in its entirety.

### BACKGROUND

Previous approaches for legacy application and database transformation have faced significant technical challenges. One challenge is that legacy systems frequently feature complex and tightly coupled components. These intricate and interdependent components are connected in different ways, making them difficult to untangle and modernize.

This challenge is compounded by a lack of documentation and expertise relating to legacy systems. Since legacy systems are usually several years old, the original developers are often unavailable and documentation is either scarce or outdated, making understanding of these legacy systems a significant hurdle.

Another drawback of existing legacy transformation systems is that many of these systems have involved a piecemeal approach that adds features to an existing system to retrofit the older system for modern usage. This approach does not address the outdated cores of older systems and only compounds the complexity of the legacy system.

There are currently no systems for transforming legacy code and legacy databases that can properly understand the complexity of different legacy systems or initiate a full transformation of legacy systems.

### BRIEF DESCRIPTION OF THE DRAWINGS

FIG. 1 illustrates a flowchart for executed by one or more computing devices of a migration platform for legacy database migration with a large language model according to an exemplary embodiment.

FIG. 2 illustrates a flowchart for applying a large language model to the legacy database to extract one or more legacy database values according to an exemplary embodiment.

FIG. 3 illustrates a flowchart for applying the large language model to legacy application code that interfaces with the legacy database to extract one or more legacy application values according to an exemplary embodiment.

FIG. 4 illustrates a flowchart for determining a plurality of destination database values corresponding to a destination database based at least in part on the one or more legacy database values and the one or more legacy application values according to an exemplary embodiment.

FIG. 5 illustrates a flowchart for generating migration code for migrating the legacy database to the destination database based at least in part on one or more code generation templates, one or more user preferences, and one or more code generation procedures configured to create one or more files and one or more directories based at least in part on the one or more code generation templates according to an exemplary embodiment.

FIG. 6 illustrates a flowchart for validating the migration code based at least in part on generating mock data, storing the mock data in the legacy database, and applying the migration code to the mock data to migrate the mock data to the destination database according to an exemplary embodiment.

FIG. 7 illustrates a flowchart for executing the validated migration code to perform a migration of the legacy database to the destination database according to an exemplary embodiment.

FIG. 8 illustrates a system diagram of the migration platform, a legacy database environment, and a destination database environment according to an exemplary embodiment.

FIG. 9 illustrates the specialized computing environment of the migration platform that is used to perform the above-described methods and implement the above-described systems according to an exemplary embodiment.

### DETAILED DESCRIPTION

While methods, systems, and computer-readable media are described herein by way of examples and embodiments, those skilled in the art recognize that methods, apparatuses, and computer-readable media for legacy database migration with a large language model are not limited to the embodiments or drawings described. The drawings and description are not intended to be limited to the particular form disclosed. Rather, the intention is to cover all modifications, equivalents and alternatives falling within the spirit and scope of the present disclosure and claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” and “includes” mean including, but not limited to.

Applicant has discovered a legacy system migration platform (also referred to herein as the “Co-Pilot” and the “Migration Platform), method, apparatus, and computer-readable medium that addresses the above-mentioned problems. The Co-Pilot presents an innovative method, apparatus, and computer-readable medium designed to analyze source code and generate comprehensive README documentation. Going beyond traditional code analysis, Co-Pilot leverages vectorization techniques and a vector store to provide insightful responses to user queries. It is capable of generating detailed and summarized explanations for code, offering both an immediate overview and in-depth understanding when needed.

The present system includes the following features:
Legacy Code Understanding: By leveraging LLMs, the Co-Pilot can interpret the legacy code and database structures, serving as a subject matter expert that can guide the modernization process. Based on known techniques for transformation, the stages and tasks involved in such transformations are understood. The exact nature of a transformation process and a desired output are also understood from known techniques. Based on this knowledge, LLMs are trained with an iterative process, which may be referred to as “Prompt Engineering,” by designing the correct stages of transformation and iteratively working through the correct prompt design to achieve the desired output. But because typical transformations rely on direct conversions, and direct conversion of legacy code to new code does not work, the present system is built with clear intermediation, which uses the LLM to understand the code and generate functional documentation. This documentation can then be used to implement desired functionality in a new tech stack with human interaction, e.g., known Human-In-The-Loop techniques. For example, a complexity factor in transforming services can be a number and nature of CRUD operations done by a service. And a service that performs inquiries on 1 field is less complex than a service that works across multiple fields. Based on this and other rules, such as Inline SQL queries and usage of ORM frameworks, the LLM can analyze the legacy code to classify code based on complexity and can analyze the database structures, such as but not limited to, logs, to identify most frequently executed queries. These analyses provide an overall picture of the data for transformation.
Insights and Recommendations: The present system analyzes and provides recommendations regarding a target/destination database schema model, code, while optimizing for performance according to the destination environment and parameters. The Co-Pilot can use a set of contexts, including but not limited to, database design, data access patterns, schema design guidelines for a NoSQL database type, such as a MongoDB environment, and a standard domain modeling for various domains. These contexts and a set of correct prompts are given to the LLM to design a new desired schema. Based on these contexts and prompts, schema is derived. As a non-limiting example, a source schema may include a Product table and an Order table. If Co-Pilot identifies a data access pattern, such as a Product description is always requested by a user for a user's orders, then Co-Pilot can use one or more source schema guidelines to ensure that the target schema contains data consistent with the data access pattern, here the Product description along with the Order entity, rather than performing a lookup every time. In addition, Co-Pilot can also look at a known domain model, for example an eCommerce domain, and identify a database design therefrom. In this example, therefore, the resulting schema may be derived from the Product table and the Order table. (e.g., the source schema), a data access pattern that the Product description is always requested with a user order request, a source scheme guideline to satisfy the data access pattern and store the Product description with the requested user order data, and a known domain model, e.g., an eCommerce domain model.
Automatic Code Generation: The generative AI component of the system generates target data model and code that will be compatible with modern, cloud-native platforms, speeding up the transformation process.
Code Validation: The system leverages the generative AI component to generate needed test/mock data. The generated code is then tested for functional accuracy and performance using the test data to validate migration code and initiate data migration.
Data Migration: The Copilot coordinates the scheduling and migration of the application and data into the destination database (e.g., a cloud-based database, such as a MongoDB environment).
Dashboard for ongoing Operation: The Copilot leverages GenAI to provide ongoing insights across the data and code to a client's operational dashboard.
Comprehensive Code Analysis: PeerAI automatically reviews source code and generates a detailed README file that includes explanations of the code's functionality, dependencies, and structure.
Vectorized Code Storage: The system converts the analyzed source code into vectorized representations using specialized techniques. These vectors are stored in a vector store, such as a NoSQL vector store, facilitating efficient retrieval of code information based on user queries.
Intelligent Query Responses: Users can ask questions related to the analyzed code, and the system retrieves relevant information from the vector store. The system is capable of returning both summarized and detailed explanations, allowing users to choose the level of detail they need.
Efficient Information Retrieval: The use of vector storage ensures that code-related data can be retrieved quickly and efficiently, especially in scenarios where users require insights from large codebases.

Co-Pilot can also help in generating unit test cases for generated code, generating test data for performance testing, and understand the code and recommend performance improvements.

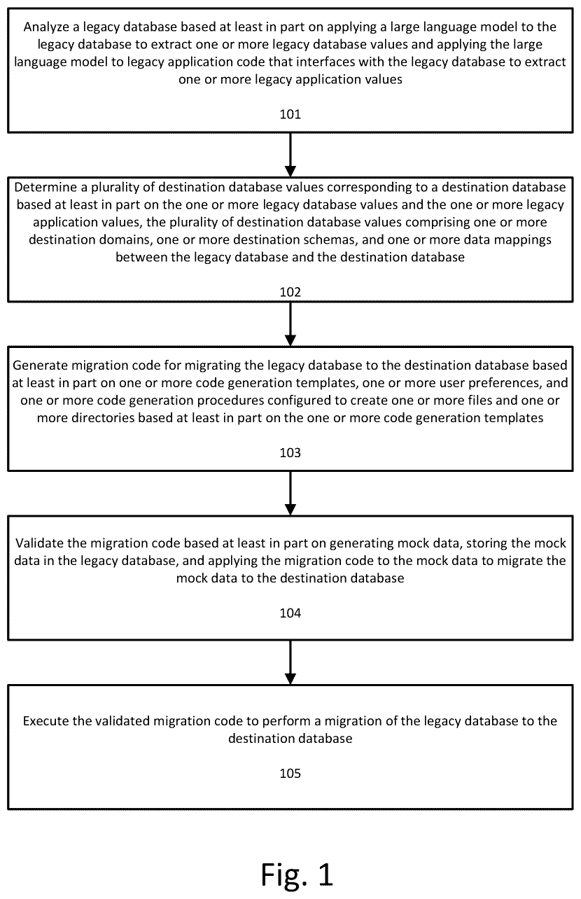

FIG. 1 illustrates a flowchart for executed by one or more computing devices of a migration platform for legacy database migration with a large language model according to an exemplary embodiment. Each of the steps shown in FIG. 1 can be executed by the one or more computing devices of the migration platform. Of course, the present system can be utilized for any legacy application or legacy system migration, including systems that do not involve databases.

At step 101 a legacy database is analyzed based at least in part on applying a large language model to the legacy database to extract one or more legacy database values and applying the large language model to legacy application code that interfaces with the legacy database to extract one or more legacy application values.

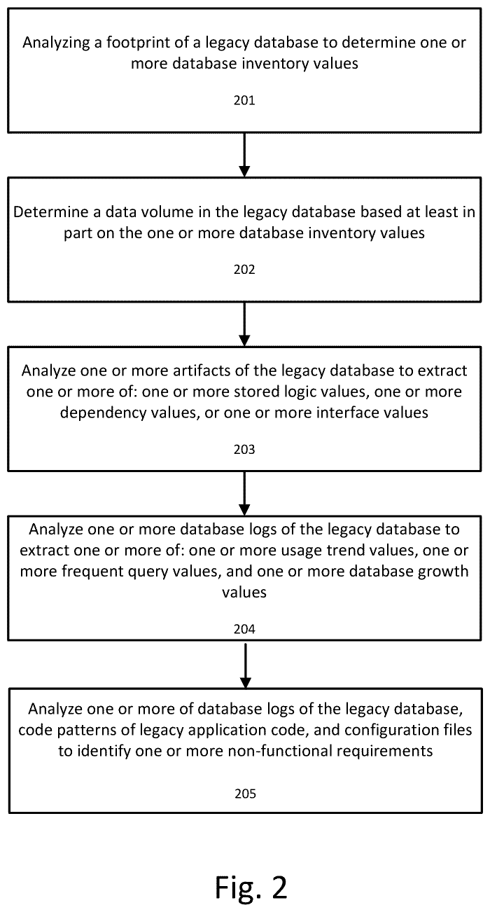

FIG. 2 illustrates a flowchart for applying a large language model to the legacy database to extract one or more legacy database values according to an exemplary embodiment. The process of applying the large language model to the legacy database to extract one or more legacy database values can include one or more of the steps shown in FIG. 2.

At step 201 a footprint of a legacy database is analyzed to determine one or more database inventory values. This step generates an inventory of the database and documents all tables, columns, indexes, constraints, and relationships in the SQL database. This includes determining the purpose of each table and how it relates to other tables. Corresponding metadata can be organized and stored in a document database to enable indexing and retrieval for analysis. The metadata can further be vectorized, stored in a vector store, and provided to or retrieved in structured formats, such as a JSON, to maintain accessible and consistent context across processes. This step can also include an automated data ingestion process, such as via an API or a direct SQL query, to extract metadata from the database. This data ingestion can include reading system catalogs, such INFORMATION SCHEMA in SQL databases, to pull table structures, columns, data types, constraints, and relationships. If permissions are restricted, the ingestion process can include retrieving a schema file granting the required permissions, or alternatively a user can provide the required permissions.

To determine the purpose of each table and how it relates to other tables, relationship data is gathered. A table's purpose can be determined by analyzing table names, column layouts, typical usage patterns, and relationship to other tables, e.g., “managing customer transaction details, encompassing items ordered, payment statuses, and shipping information.” To identify these relationships, ER diagrams can be used for visual insight, or queries of the INFORMATION_SCHEMA schema in an SQL database can access metadata on tables, columns, keys, and constraints. Analyzing cardinality (frequency of relationships) supports schema decisions, such as embedding or referencing data, based on usage patterns. This contextually organizes all this information and also additional information like cardinality for the purposes of migration. Example relationship patterns in a database that illustrate how tables connect can include:
One-to-One: Each record in one table links to one in another (e.g., Employee and EmployeeDetails).
One-to-Many: One record in a table relates to multiple records in another (e.g., Order and Product).
Many-to-Many: Multiple records connect across two tables via an intermediary table (e.g., Student and Course).
Self-Referencing: A record relates to another in the same table (e.g., employee hierarchy).
Polymorphic: A record links to multiple table types (e.g., comments on posts, images, or videos).

At step 202 a data volume in the legacy database is determined based at least in part on the one or more database inventory values. This step can include measuring the data volume in each table, determining the size of the database in terms of storage space used and the number of rows in each table. This step can also include determining data growth patterns over time by analyzing historical data on table sizes, row counts, and index sizes, through database system tables or logs that record this historical data over time intervals. This can include querying system tables that track cumulative statistics, including data volume growth and index usage to understand historical data volumes and growth patterns for each table. As used herein, determining or considering data growth patterns means to analyze how the size and usage of database tables change over specific intervals, such as daily, monthly, or yearly to anticipate future storage needs. This insight ensures the target database is designed to handle both current and future projected data volumes efficiently. Data growth patterns can be categorized into three categories:
Consistent Growth: Tables that steadily increase in size, needing ongoing resource scaling.
Cyclical Growth: Tables with periodic spikes, requiring temporary scaling.
Rapid Growth: Fast-growing tables that may need partitioning or other optimizations.

At step 203 one or more artifacts of the legacy database are analyzed to extract one or more of: one or more stored logic values, one or more dependency values, or one or more interface values. Database artifacts can include objects such as stored procedures, tables, indices, functions, views, triggers, and/or any custom types/domains that impact schema design. This step can parse and analyze these database objects to determine their purpose, dependencies, and the tables they interact with. This step can additionally include extracting the logic from stored procedures and functions to determine their functionality.

As used herein, views refer to virtual tables that present data from one or more tables, often used for simplifying complex queries, packages refer to collections of related procedures and functions, typically in PL/SQL, and triggers refer to automated actions that run in response to certain events on tables (e.g., before or after updates).

Step 203 can include the LLM receiving or retrieving SQL DDL scripts for stored procedures, functions, views, and other objects. The LLM then extracts key information about each object, such as its purpose, dependencies, and interactions with tables. Where a package contains multiple SQL artifacts (such as multiple procedures within a package), a custom parsing step can be performed to isolate individual SQL components within the package, such as stored procedures, functions, views, and triggers. Each extracted artifact is then individually fed to the LLM, which analyzes each artifact to extract detailed insights. This structured approach ensures that each SQL object, whether standalone or part of a larger package, is thoroughly analyzed by the LLM to provide comprehensive information about its function, dependencies, and table interactions. The LLM can determine, for example, all the stored procedures that interact with a particular table, which stored procedures are accessing multiple tables, and which tables are typically used together. This analysis can be provided in a markdown or JSON format, containing descriptions, purpose, and key functionalities of each data object. After generating insights, the structured information is parsed and stored in a NoSQL database. Each database object's purpose, dependencies, and relationships with other tables are indexed, enabling efficient retrieval and further downstream analysis.

Step 203 can further include extracting logic from the database artifacts, such as stored procedures and functions. The LLM extracts logic from database artifacts by responding to carefully crafted prompts that instruct the LLM to identify specific details within each database artifact. These prompts direct the LLM to analyze the structure and intent of the corresponding database code, focusing on extracting key components so the LLM can systematically analyze and summarize the logic within each database artifact, providing structured insights that are stored for downstream processing. Examples of key component extracts include, but are not limited to:
Purpose: The LLM can interpret a main objective of the database artifact (e.g., if it's a stored procedure, the prompt might ask it to explain the procedure's purpose based on its name and operations).
Dependencies: Prompts direct the LLM to identify tables, columns, and other database objects referenced within the corresponding database code. For example, the LLM can be prompted to list all tables joined or columns selected, revealing dependencies and relationships.
Logic Flow: The LLM can be trace a sequence of operations within the corresponding database code, including any conditional or control flow statements (e.g., IF-THEN, loops). This helps in understanding logical flow and operations performed by a particular database artifact.
DML Operations: The LLM can count or describe Data Manipulation Language (DML) statements such as SELECT, INSERT, UPDATE, and DELETE, giving insight into data operations within a database artifact.
Control Statements and Business Rules: The LLM parses the database artifact for business rules or control logic, identifying key conditions or calculations that define the artifact's function.

At step 204 one or more database logs of the legacy database are analyzed to extract one or more of: one or more usage trend values, one or more frequent query values, and one or more database growth values. This step can include analyzing the database logs to identify usage trends, such as determining if the database experiences read-heavy or write-heavy operations and determining the peak usage times. Usage trends can be groups by tables and query types to provide clear views of which database components are actively used and their relational patterns, providing a level of detail to optimize database performance, security, and resource allocation. Further examples of usage trends identified in the analysis include, but are not limited to:
Query Access Patterns: These trends capture the types of queries executed frequently, such as SELECT, INSERT, UPDATE, and DELETE operations. This helps identify which tables are most commonly accessed and the nature of the operations performed.
Top Queries: The analysis highlights the most frequently executed queries across different tables, which can indicate “hot” tables, e.g., tables that are frequently access for query execution, or heavily used areas of the database. These queries are logged with details such as the frequency of execution and the specific fields accessed in the query.
Tables Accessed Together: This trend shows which tables are accessed together in queries, often through JOIN operations. It reveals common relational patterns and dependencies across tables, aiding in understanding data flow and inter-table dependencies.
Trend Analysis: Usage trends can also be broken down by time intervals (e.g., hourly or daily) to capture temporal patterns in database usage. This includes monitoring the count of each type of query, active connections, and users involved during specific time windows.
User-Specific Trends: The analysis tracks which users are active within particular intervals, providing insight into user-specific patterns, such as frequent query types or specific tables accessed by individual users.

The performance of these queries can also be analyzed to determine performance and resource utilization, including but not limited to response times, query execution details, query duration, lock contention, and metrics related to I/O and cache usage. Additional monitoring tools or configurations can be integrated to provide detailed insights into CPU and memory utilization on a per-query basis. This step can additionally include monitoring database growth over time to ensure that it aligns with projections and capacity planning for the destination database.

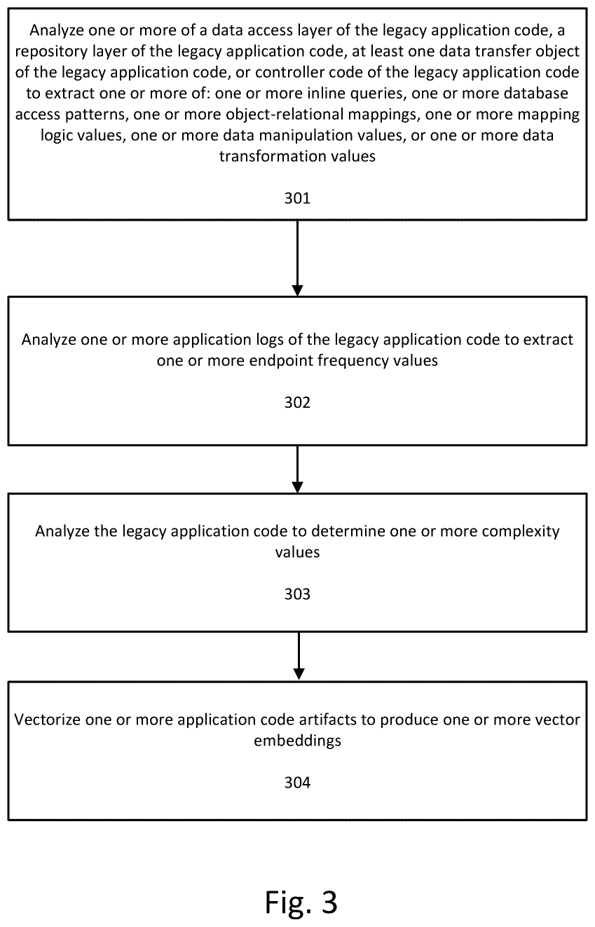

At step 205, one or more of database logs of the legacy database, code patterns of legacy application code, and configuration files are analyzed to identify one or more non-functional requirements. These non-functional requirements can, but are not limited to, response time, data security requirements, and system reliability requirements. Identifying these non-functional requirements helps ensure adherence to compliance, performance, and scalability standard/requirements and prevent performance degradation. While illustrated in FIG. 2 as step 205 of method 200, this step may alternatively be performed as an additional step of method 300 shown in FIG. 3.

FIG. 3 illustrates a flowchart for applying the large language model to legacy application code that interfaces with the legacy database to extract one or more legacy application values according to an exemplary embodiment. The process of applying the large language model to the legacy application code to extract one or more legacy application values can include one or more of the steps shown in FIG. 3.

At step 301 an analysis is performed on one or more of: a data access layer of the legacy application code, a repository layer of the legacy application code, at least one data transfer object of the legacy application code, or controller code of the legacy application code to extract one or more of: one or more inline queries, one or more database access patterns, one or more object-relational mappings, one or more mapping logic values, one or more data manipulation values, or one or more data transformation values. This step can include one or more of the following substeps:
Data Access Layer: Analyzing the data access layer of the application by analyzing the application code to be transformed to determine how the application retrieves, stores, manipulates, or otherwise interacts with data in the database. This can include analyzing data access patterns, including but not limited to common operations such as SELECT, INSERT, UPDATE, and DELETE, within the data access layer to understand typical data flows and interactions with database tables. This can further include examining repository or DAO (Data Access Object) classes that manage database interactions, identifying the structure and relationships between the application and database tables. This can further include detecting inline SQL queries or dynamically generated SQL statements embedded within the application code, which are often found in controller or service layers. These queries are mapped to specific tables and fields in the database to understand their impact on data access. When multiple applications access the same database, each is can be analyzed separately, provided the data access layer of each has been explicitly processed to capture the distinct data access patterns unique to each application as expressed in each application code. Additional factors such as frequency, dependencies, and complexity of application code interactions with the database can be examined. This can identify areas of high dependency or complexity that may require re-architecture or optimization for better performance and scalability in the target environment.
Repository Layer: Examining the repository or data access classes to identify data retrieval and storage methods and checking for ORM (Object-Relational Mapping) usage if applicable. The repository layer is an abstraction between the application and the database that provides a “clean” interface for data access by centralizing CRUD operations and using ORM frameworks to make data access code easier to maintain and modify. Identifying data retrieval and storage methods in the repository layer means recognizing specific methods used to access and manipulate data in the database, such as retrieving, saving, updating, and deleting data. These methods can, for example, encapsulate SQL queries or ORM logic, thus providing a centralized way to interact with database entities. For example, in a Java Spring Boot application, the repository layer can be implemented using Spring Data JPA.
DTO (Data Transfer Object): Determining how data is mapped between the database and application through DTOs and identifying the structure and mapping logic used for data transfer. DTOs are lightweight objects used to transfer data between layers of an application, such as between the database and the front end. They help streamline the data needed for specific tasks without including extra information. In migration, DTOs can simplify the process by ensuring only essential data is transferred. By comparison, ORMs (Object-Relational Mappers) are tools that map database tables to code objects, allowing applications to interact with the database without writing SQL. They handle CRUD operations, relationships, and transactions. During migration, ORMs simplify the mapping of SQL data to new structures (like MongoDB) by centralizing data access logic. While both DTOs and ORMs deal with data, ORMs directly interact with the database, while DTOs carry data between application layers without involving the database itself.
Controller: Analyzing the controller code to determine how it interacts with the data access layer and DTOs and identifying any data manipulation or transformation within the controller. As used herein, a Controller is an application layer that handles requests and directs them to the appropriate service or repository methods for data handling. Analyzing controllers helps to understand, for example, data flow (i.e., how requests are processed and directed to retrieve or modify data, database interactions (i.e., which services or repositories the controller calls for database access, helping map out key database interactions. This analysis helps identify data access patterns, dependencies, and points of interaction between an application and a database. When Co-Pilot reviews the controller code, it classifies interactions based on how the controller communicates with the data access layer, such as through service or repository methods, and uses DTOs to manage data flow. Co-Pilot organizes these interactions into types that help map data flows and dependencies for optimized analysis or migration. Exemplary interaction types include, but are not limited to:
Data Retrieval: This includes interactions that fetch data from the database, e.g., getUserProfile calls UserService.getUserById and populates a DTO.
Data Modification: This includes interactions that create, update, or delete data, e.g., createOrder calls OrderService.saveOrder with order details.
Validation and Transformation: This includes interactions that applies business rules or transforming data before performing database actions, e.g., registerUser validates a DTO, then calls UserService.createUser.

To extract data manipulations and transformations in the controller, Co-Pilot analyzes the controller code using targeted prompts to identify specific patterns and keywords associated with validation, formatting, mapping, and aggregation. Extracting each of data validation, formatting, mapping, and aggregation include:
Data Validation: Co-Pilot parses the controller code for validation libraries or custom validation functions (e.g., validateEmail( ), or annotations like @Valid). These help Co-Pilot detect where input rules are enforced before data processing.
Data Formatting: Co-Pilot parses the controller code for string or date formatting functions, such as formatDate( ) or toUpperCaseO, signaling adjustments made to data for consistency. Co-Pilot then flags these as formatting operations to understand how data is standardized.
Data Mapping: Co-Pilot parses the controller code to identify mapping actions by looking for explicit assignments or transformation methods that convert DTO fields to entity fields (e.g., userDTO.getFirstName( ) mapped to User.firstName). This shows how data is structured before database insertion.
Data Aggregation: Co-Pilot parses the controller code to detect aggregation patterns by searching for concatenation or calculation logic (e.g., combining fields like firstName+““+lastName for fullName). This helps Co-Pilot understand composite data preparations.

Identifying inline SQL queries and database access patterns in the data access layer provides the system with a detailed map of how an application interacts with a database. This information is critical for migration and code refactoring in several ways, including but not limited to:
Schema Design for Migration: During migration, Co-Pilot uses access patterns to design a destination schema that aligns with real usage. Knowing which tables and fields are accessed frequently or used in complex joins allows Co-Pilot to decide between embedding or referencing data, optimizing for common query patterns in the destination—schema.
Refactoring Inline SQL Queries: Inline SQL queries bypass centralized data access controls, making them challenging to maintain and secure. Co-Pilot identifies these queries and suggests refactoring them into repository or service classes to centralize data access logic. This not only improves maintainability but also helps ensure that queries are compatible with the target database in a migration scenario.
Performance Optimization: Inline SQL and specific access patterns often reveal bottlenecks or heavy query loads on certain tables. Co-Pilot flags these patterns for indexing or restructuring in the new database schema. For example, frequently joined tables in SQL might be embedded in a NoSQL database to reduce query complexity and improve performance in the destination database environment.
Security Hardening: Co-Pilot flags dynamically constructed SQL queries that are vulnerable to SQL injection. During code refactoring, these are identified for conversion into parameterized queries or for abstraction into data access layers, increasing security in the application.

The extracted information is stored in structured formats, such as JSON, allowing for systematic tracking of data access dependencies and refactoring recommendations, which can be applied during migration or code adjustments.

At step 302 one or more application logs of the legacy application code are analyzed to extract one or more endpoint frequency values. In this context, an “endpoint” refers to an application's specific API route or URL that handles requests for certain operations, rather than a direct database access point. Each endpoint corresponds to a defined functionality, such as, but not limited to, retrieving, updating, or deleting data. Each endpoint interacts with a database indirectly by calling service or repository methods. This step can include Co-Pilot tracking these endpoints to understand application usage patterns and how often data is accessed or modified, calculating a frequency with which each endpoint is called and providing a count of how many times each endpoint is accessed. By understanding the most frequently used endpoints and understanding the functionality of the endpoints, Co-Pilot can understand the nature/usage of the application to make insights about the application. Examples of endpoints include, but are not limited to:
GET/api/users/{id}: This endpoint retrieves user data for a specific user ID.
POST/api/orders: This endpoint creates a new order with details provided in the request body.
PUT/api/products/{id}: This endpoint updates the product information for a given product ID.
DELETE/api/customers/{id}: This endpoint deletes a customer record for the specified ID.

At step 303 the legacy application code is analyzed to determine one or more complexity values. This step can include complexity benchmarking which categorizes stored procedures, functions, views, packages, triggers, and other database objects into small, medium, or high complexity based on criteria such as lines of code, the number of joins, and/or the complexity of their logic. This classification can then be utilized to prioritize optimization efforts.

At step 304, one or more artifacts of the legacy application code is vectorized to produce one or more vector embeddings. This step can include analyzing code artifacts, including but not limited to, stored procedures, schema structures, and documented business logic, and converting them into vector embeddings. These vector embeddings can be stored in a database, and when a user query is received, the user query can be compared to the stored vector embeddings and a most relevant vector embedding can be retrieved. This step helps increase retrieval speed and insight accuracy when receiving user queries that are similar to these code artifacts.

Returning to FIG. 1, at step 102 a plurality of destination database values corresponding to a destination database are determined based at least in part on the one or more legacy database values and the one or more legacy application values, the plurality of destination database values comprising one or more destination domains, one or more destination schemas, and one or more data mappings between the legacy database and the destination database.

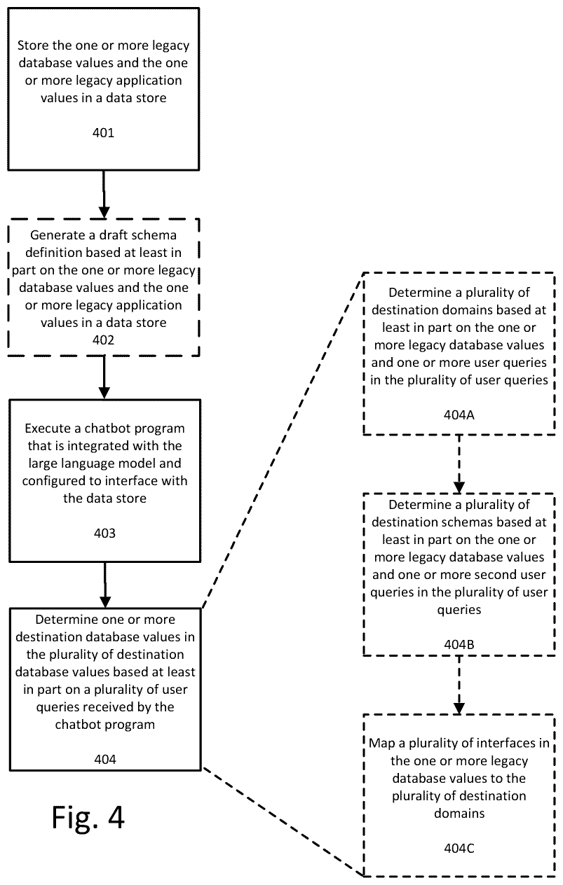

FIG. 4 illustrates a flowchart for determining a plurality of destination database values corresponding to a destination database based at least in part on the one or more legacy database values and the one or more legacy application values according to an exemplary embodiment. The process of determining a plurality of destination database values corresponding to a destination database based at least in part on the one or more legacy database values and the one or more legacy application values can include one or more of the steps shown in FIG. 4.

At step 401 the one or more legacy database values and the one or more legacy application values are stored in a data store. The legacy database values can include any of the values described with respect to steps 201-204 of FIG. 2. The legacy application values can include any of the values described with respect to 301-303 of FIG. 3. These values are stored on the migration platform and leveraged to determine the desired properties of the destination database, as described below.

At an optional step 402, a draft schema is generated based at least in part on the one or more legacy database values and the one or more legacy application values are stored in the data store in step 401. By gathering legacy database values and legacy application values, the current table structures can be classified based on whether they are transactional or reference tables, and the access patterns of these tables can be understood. Examining the application code to identify data access methods and data interfaces provides an understanding of how data is retrieved, updated, and passed between services, which aids in structuring the draft schema to best support the needs of the application corresponding to the application code. Code clustering can also be performed, grouping similar code components that access or manipulate related data together. This clustering aids in identifying natural boundaries for collections and determining when to embed or reference data based on code dependencies and access patterns, which are reflected in the one or more legacy database values and/or the one or more legacy application values. And because NoSQL databases do not require any particular 3N database design, the draft schema model can be determined based on data usage and access patterns by understanding cardinality of data referenced. Based on these, Co-Pilot takes a call on whether to embed data as part of an original entity itself or to keep it separate from the original entity. A draft schema design is then generated and can be presented to a user in an interface. As discussed further with respect to step 403, a user can then interface with the data store and via a chatbot program to customize the draft schema generated in step 402.

Step 402 can further include selecting an instance size. For example, if a current data volume is 100 s of GBs then a lower instance can be selected for the draft schema. But if the current data volume is in TBs, then a larger instance size is needed. Similarly, instance size can be driven by IOPS and RAM requirements. For date sizes exceeding 2 TBs, sharding strategies can be implemented to partition the schema. In addition, a correct migration strategy can be provided based on the current data volume and based on the degree of change between the source schema and the draft schema. If highly transactional Co-Pilot can implement Change Data Capture (CDC). Index recommendations based on current indexes and access patterns can further be considered in selecting an instance size in the 402.

Step 402 can further include generating template code (e.g., pDSL) for all the entities. This can include migrating existing code, which can include documenting existing code and ingesting the documentation to make the documentation available to query. Users can then question the functionality of the current code and understand the code better, e.g., through the chatbot program described with respect to step 403. Users can implement the same functionality in the desired tech stack, and both existing and new code can be documented in various formats, e.g., sequence diagrams, class diagrams, word documentation, etc.

At step 403 a chatbot program that is integrated with the large language model and configured to interface with the data store is executed. The chatbot can be integrated into the system to provide users with a natural language interface for interacting with the analyzed and stored data. Users can interact with the chatbot by providing natural language queries or requests related to data domains and schema generation.

When a user provides a natural language query to the chatbot, the query is vectorized. A RAG based architecture is used to query the relevant information from the data store for the analyzed data. The query and the relevant information retrieved from the data store is then fed to an LLM, and the LLM constructs the output and provides it to the user. The user can interact with the chatbot via predefined prompts, or alternatively, the user can provide its own queries to the chatbot that are not based on predefined prompts. Examples of natural language queries can include, but are not limited to,

“List all inline SQL queries used within the controllers.”

“Identify stored procedures invoked from within the service layer.”

“What data transformations occur within the controller layer?”

“Can you list all tables accessed directly within the service classes?”

“List CRUD operations directly embedded in application code.”

Additional exemplary requests related to data domains and scheme generation, and exemplary chatbot response, include but are not limited to:

Request: “Can you generate a schema for the customer and orders data domain?”

Response: “For the Customer and Orders data domain, the suggested schema includes two collections. The Customer collection contains fields like customer_id, name, email, and address. The Orders collection stores order_id, customer_id, order_date, order_items, and total_price. Depending on access patterns, we could embed recent orders directly within the Customer collection for faster retrieval or keep them separate and use references.”

Request: “What's a suitable schema for managing inventory, suppliers, and purchase orders?”
Response: “A suitable schema involves three collections:
Inventory: Fields—product_id, product_name, quantity_in_stock, supplier_id.
Suppliers: Fields—supplier_id, supplier_name, contact_info.
PurchaseOrders: Fields—order_id, supplier_id, items_ordered (array with product_id, quantity_ordered), status.

Response Schema Design:
Links: supplier_id in Inventory and PurchaseOrders references Suppliers.
Embedded Data: items_ordered stored within PurchaseOrders for quick access.
Indexing: Key fields indexed for efficiency.

This setup optimizes inventory, supplier, and order tracking”

At step 404 one or more destination database values in the plurality of destination database values is determined based at least in part on a plurality of user queries received by the chatbot program.

The step of determining one or more destination database values in the plurality of destination database values based at least in part on one or more user queries received by the chatbot program can include one or more of steps 404A-404C.

At step 404A a plurality of destination domains are determined based at least in part on the one or more legacy database values and one or more user queries in the plurality of user queries. a user can query the chatbot to identify data domains. The chatbot can utilize vector search technology to search through pre-analyzed and stored data. Vector search can efficiently find similar items in the dataset, helping identify relevant data domains based on user input.

At step 404B a plurality of destination schemas are determined based at least in part on the one or more legacy database values and one or more second user queries in the plurality of user queries. If a user requests schema generation for a specific data domain, the chatbot can use predefined schema templates to create schemas, such as known MongoDB schemas. Known schema templates can include models frequently used in particular industries, such as a schema model for patient information used in the medical industry. This schema can be based on the characteristics and data elements associated with the identified domains. The user can interact with the chatbot via queries and modify the information in the schema template to generate a customized destination schema.

At step 404C a plurality of interfaces in the one or more legacy database values are mapped to the plurality of destination domains. This step can include examining the existing interfaces based on the analysis of the code artifacts and mapping them to the identified domains. This ensures that the correct schema design is generated based on the characteristics and data elements associated with the identified domain. For example, ORMs directly interact with the database, while DTOs just carry data between application layers without involving the database. The ORMs will map database tables to code objects and handle CRUD operations, relationships, and transactions. Thus, during migration, ORMs simplify the mapping of SQL data to new structures (like MongoDB) by centralizing data access logic. The DTOs transfer data between layers of an application, such as between the database and the front end and help streamline the data needed for specific tasks without including extra information. In migration, DTOs can simplify the process by ensuring only essential data is transferred.

The step of determining destination database values can additionally include determining a methodology that supports various migration strategies, such as rewriting an application or maintaining a hybrid setup for a transition period. This can include designing a migration methodology by guiding the user through predefined prompts and providing recommendations based on the current system architecture, data dependencies, and performance requirements. The chatbot suggests strategies, identifies risks, and offers best practices tailored to the application's characteristics.

The steps of a migration methodology can include, but are not limited to:
Data and Schema Analysis: This can include analyzing the legacy database schema, identifying relational patterns, frequently accessed tables, and complex joins that may impact migration.
Schema Mapping: This can include mapping relational schema to document-oriented schema, making decisions about embedding or referencing based on access patterns.
Data Transformation: This can include preparing data for the destination schema, including tasks like data cleansing, format standardization, and denormalization where needed.
Data Transfer Planning: This can include identifying data transfer strategies (e.g., bulk load or incremental updates) based on database size and acceptable downtime.
Testing: This can include performing data validation and query performance testing to ensure the destination schema meets functional and performance requirements.
Deployment and Validation: This can include deploying the destination schema, monitoring it, and validating for consistency and performance.

Exemplary, non-limiting migration strategies include:
One-Time Migration: A one-time, bulk migration strategy can be used when the data is less frequently updated or there's a downtime window available. This is often used for applications that can tolerate downtime during the migration.
Incremental Migration: Used when data in the legacy system is continuously updated. This involves ongoing data synchronization until the switch to the destination schema is fully ready. Incremental migration leverages Change Data Capture (CDC) techniques to keep both databases in sync.

Returning to FIG. 1, at step 103 migration code for migrating the legacy database to the destination database is generated based at least in part on one or more code generation templates, entity definitions, legacy code analysis, schema mapping information, one or more user preferences, and one or more code generation procedures configured to create one or more files and one or more directories based at least in part on the one or more code generation templates. This step can include receiving the schema and entity information for the new system, selecting a controller template for managing CRUD operations for a particular entity (e.g., “Product”), based on the schema, filling in specific fields, mappings, and any validation rules, generating customized queries or operations based on parameters like entity relationships, data constraints, and access patterns are considered, and saving the generated code, completing any additional setup (e.g., adding route mappings), and providing documentation. Then, the code can be validated and edited by a user to generate the final migration code.

As explained below, the Co-Pilot can create migration code through a combination of pre-built artifacts from a stored repository, net new code and AI generated code based on the provided tech stack. Pre-built artifacts are ready-made components that accelerate code generation, such as a repository template that standardizes CRUD operations on a No-SQL database, a service template for encapsulating business logic, and validation snippets for verifying input data against constraints. Pre-built artifacts can be categorized into the following:
Templates: Pseudo-code structures for controllers, services, and repositories. These represent typical patterns, such as CRUD operations, database connection setup, or entity definition. These templates act as foundational code patterns that are further customized based on parameters such as entity type, attributes, and functionality. Controller templates can include templates for API endpoints, e.g., GET/entity/{id}, POST/entity. Services templates can include business logic encapsulation, such as handling CRUD operations and validation. Repository templates can include data access layer templates, such as using JPA or MongoDB. Models/Entities templates can include basic entity classes with fields, relationships, and annotations.
Business Logic Snippets: Code blocks for common logic patterns such as CRUD operations, pagination, and validation.
Database Handlers: Pre-configured handlers for MongoDB (or other databases), including connection settings and basic CRUD operations.

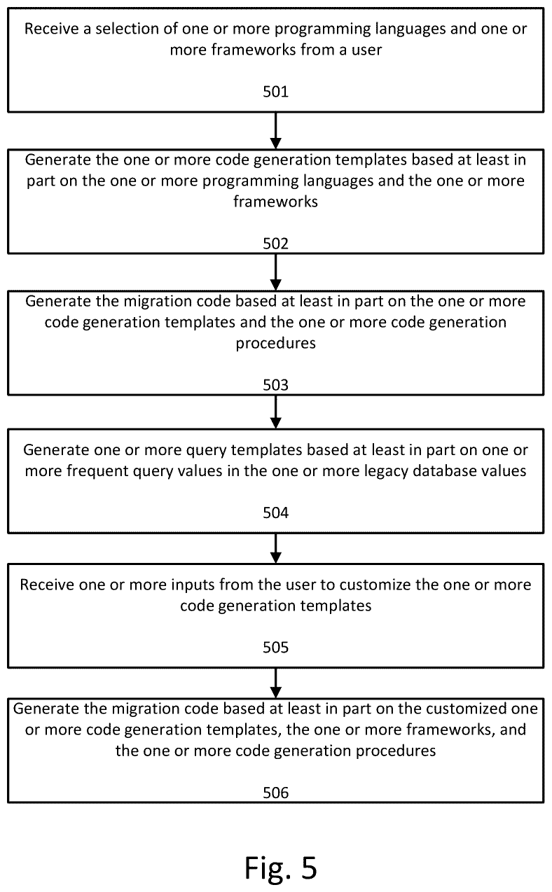

FIG. 5 illustrates a flowchart for generating migration code for migrating the legacy database to the destination database based at least in part on one or more code generation templates, one or more user preferences, and one or more code generation procedures configured to create one or more files and one or more directories based at least in part on the one or more code generation templates according to an exemplary embodiment. The process of generating migration code can include one or more of the steps shown in FIG. 5.

At step 501 a selection of one or more programming languages and one or more frameworks is received from a user. This step allows for configurable code generation and includes receiving selections from the user of the programming languages and frameworks, such as Spring Boot (Java), .NET Core (C#), NodeJS, etc.

At step 502 the one or more code generation templates are generated based at least in part on the one or more programming languages and the one or more frameworks. This step can include creating code generation templates for each target language and framework. These templates can serve as the basis for generating code and are extensible to support new frameworks and languages. Code templates can be generated for various components, such as repositories, controllers, services, models, and database access. Generating the one or more code generation templates can further be based on the schema mapping discussed above.

At step 503 the migration code is generated based at least in part on the one or more code generation templates and the one or more code generation procedures. Code generation logic can be used to create files and directories by transforming inputs such as database schema, entity definitions, and relationships into functional code snippets based on the selected templates. Creating a files using code generation logic can include selecting a template based on an entity type, replacing placeholders in the template, and writing the generated code to a specified directory, thus automating file creation and producing a well-structured directory. These generated files can be saved within a project's code based under structured folders. Additionally, this step can include generating unit tests, linting configurations, and test frameworks specific to the selected language and framework. Linting configurations refer to settings or tools that check for code style and formatting issues dependent on specific coding standards and used to enforce consistency and help identify potential errors early in development. This step can include integrating business rules and logic extracted from legacy code into the generated migration code. For example, this step can include translating SQL-based logic into a NoSQL-based query logic.

At step 504 one or more query templates are generated based at least in part on one or more frequent query values in the one or more legacy database values. This step can include generating query templates that include placeholders for query conditions, sorting, and fields, making it easier for users to create custom queries based on the top N queries. Generating query templates aids with validating data structures, verifying expected query results, and supporting load testing. These templates are derived from SQL queries applied to mock data, enabling targeted testing of data retrieval patterns, structure, and performance in the new database environment.

At step 505 one or more inputs are received from the user to customize the one or more code generation templates. This step allows users to customize the templates and add their own code generation templates. Users can further add custom logic and can correct any errors or incomplete aspects of the code to ensure the generated code aligns with a desired functionality. For example, a code generation template may define a simple CRUD operation. A user can customize the template in step 505 by adding validation or access control, such as by adding role-based access control to a controller method in a REST APO. This step can further include generate a quality score for the generated code.

At step 506 the migration code is generated based at least in part on the customized one or more code generation templates, the one or more frameworks, and the one or more code generation procedures. This can include generating fully functional migration code files for the application layers, including repositories, services, and controllers. This step can include incorporating framework-specific logic, where necessary. For example, when generating code for Spring Boot, the template can add dependency injection and annotations specific to Java documentation. This step can further include automatically generating documentation for the generated code, including API documentation, README files, and project-specific documentation.

Step 506 can further include generating net new code, which includes code modules or functions that did not exist in the legacy code and are created to support new requirements or technologies in the generated migration code. Net new code may include, for example, an authentication module that was not present in the legacy system but is required in the new application. Net new code can be generated by the Co-Pilot based on patterns in the legacy code and/or predefined templates. Alternatively, net new code can be created by a user for logic beyond what can be derived from templates or legacy code. The user may input net new code in step 506 and/or in step 505.

Returning to FIG. 1, at step 104 the migration code is validated based at least in part on generating mock data, storing the mock data in the legacy database, and applying the migration code to the mock data to migrate the mock data to the destination database. As explained below, the Co-Pilot can create applicable mock data for validation of the generated migration code. Mock data generation can be performed according to mock data generation rules that can include domain-specific constraints, such as format validations or field dependencies. This mock data can be placed in the legacy environment and the migration code can be tested using this mock data to migrate it into the destination database, such as a cloud environment. This test allows the system to validate the code for accuracy and identify any issues with the migration environment. Once complete the code and migration approach is approved and ready for live migrations. Step 104 further serves to validate the performance of the migration code to ensure that the migration code functions as the legacy application code functions, thus fulfilling the required business functionality of the legacy application code.

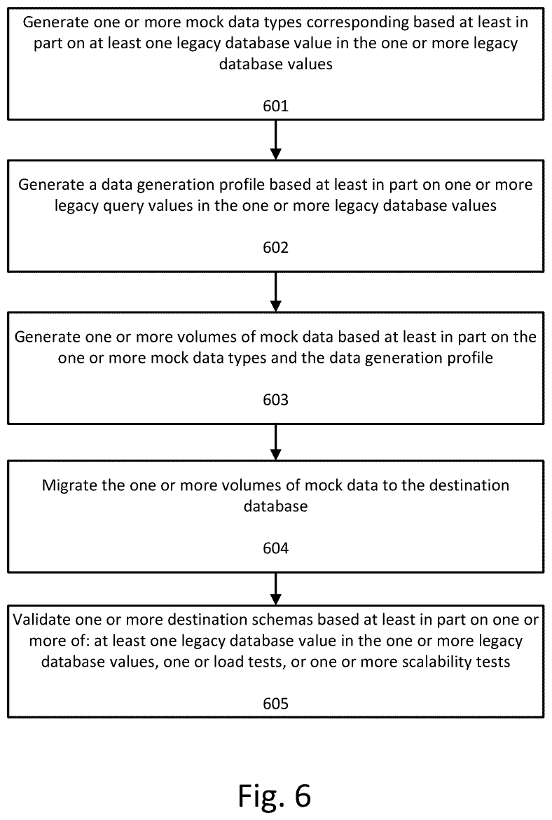

FIG. 6 illustrates a flowchart for validating the migration code based at least in part on generating mock data, storing the mock data in the legacy database, and applying the migration code to the mock data to migrate the mock data to the destination database according to an exemplary embodiment. The process of validating the migration code can include one or more of the steps shown in FIG. 6.

At step 601 one or more mock data types are generated based at least in part on at least one legacy database value in the one or more legacy database values. This step can allow the user to create or prepare mock data that simulates the data that will be migrated from the legacy environment to the new cloud environment. This mock data can cover various scenarios and data types that the migration code will encounter.

At step 602 a data generation profile is generated based at least in part on one or more legacy query values in the one or more legacy database values. This step can include generating a data generation profile that aligns with legacy query patterns and set constraints, distributions, and ranges for the generated data. As used herein, a data generation profile aligns with a legacy query pattern when the profile mimics the original data usage, this supporting the same retrieval efficiencies. Data generation profiles can further be generated by analyzing domain rules, schema requirements, and field dependencies.

At step 603 one or more volumes of mock data are generated based at least in part on the one or more mock data types and the data generation profile. This step can include generating various volumes of data to assess how the application or database performs under different loads.

At step 604 the one or more volumes of mock data are migrated to the destination database. This step includes execution of the migration code on the mock data to initiate the migration.

At step 605 one or more destination schemas are validated based at least in part on one or more of: at least one legacy database value in the one or more legacy database values, one or load tests, or one or more scalability tests. The destination schema design can be validated against application requirements and query patterns. Here, query patterns refer to both the types of queries executed (e.g., read, write, aggregations) and the load or frequency with which they occur. This includes understanding the kinds of operations—like simple reads, complex joins, tables frequently accessed together or frequent updates—and the volume or load of each. Analyzing query patterns helps design a schema that supports efficient data retrieval and modification, ensuring the database can handle the expected workload smoothly. This step can ensure efficient querying, indexing, and data retrieval in the new schema by monitoring performance metrics during test executions, adjusting indices, and optimizing data structures as needed. Tools such as Prometheus, Grafana, and Datadog can be used to track resource utilization and identify potential bottlenecks, allowing for proactive optimizations. This step can additionally include performing schema validation tests, including load and scalability performance evaluations.

Step 605 of validating one or more destination schemas can include comparing design against requirements, verifying field types, constraints, and relationships, e.g., ensuring a collection in the destination database matches relational database attributes. Steps of this step can include, but are not limited to:
Analyzing application requirements by identifying the types of queries the application runs most frequently (e.g., retrievals, updates, aggregations).
Understanding relationships between data entities (e.g., one-to-many, many-to-any) and deciding if embedding or referencing is better suited.
Optimizing for query patterns by reviewing common query patterns for efficient data retrieval. If the application frequently accesses related data together, embedding might be used. If large subsets of data are often retrieved independently, references may be used.
Evaluating indexing needs by ensuring indices align with frequently queried fields, as missing or incorrect indices can lead to poor performance.
Checking for data redundancy and consistency by avoiding redundant data unless necessary for read optimization, as this could lead to data consistency issues.

Returning to FIG. 1, at step 105 the validated migration code is executed to perform a migration of the legacy database to the destination database. This step can be performed after successful validation and during an outage window of the legacy database, to minimize disruptions. The migration includes migration of legacy data in the database and the legacy application to the destination database. This can include converting relational schema into a document-oriented structure, handling primary/foreign key transformations to embedded documents or references. As discussed below, the Co-Pilot can utilize generative AI to build target Infrastructure as a Code (IaC) scripts by interpreting high-level requirements into specific configurations and to generate and transmit an observability dashboard with interfaces to a client/user dashboard/interface. The observability dashboard provides visibility into infrastructure performance by, for example, displaying error rates, query response times, and resource utilization during and after migration.

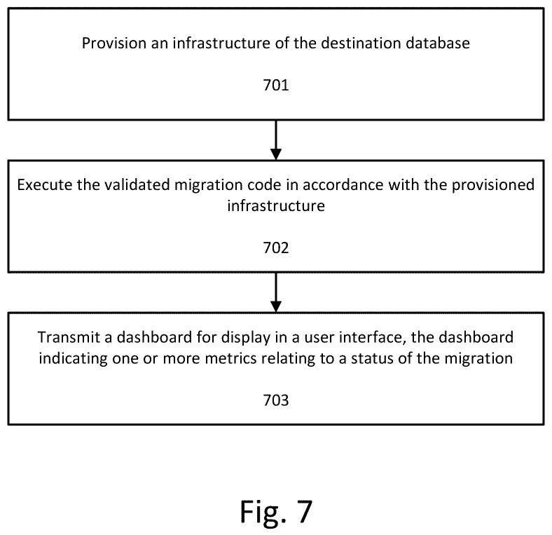

FIG. 7 illustrates a flowchart for executing the validated migration code to perform a migration of the legacy database to the destination database according to an exemplary embodiment. The process of executing the migration code can include one or more steps shown in FIG. 7.

At step 701 an infrastructure of the destination database is provisioned. This step can provision infrastructure through IaC scripts, such as terraform scripts. The provisioning can include separating resources into modules, such as network, compute, storage, and services. Terraform scripts follow a modular approach, separating network, storage, and compute resources. This ensures organized provisioning, with examples for each module. By creating a clear hierarchy and organizing resources into dedicated modules, each module can focus on a specific part of the infrastructure, like network, compute, storage, or services. A Terraform script can be structured as follows:
Network Module, which sets up VPCs, subnets, route tables, etc.
Compute Module, which provisions VMs, auto-scaling groups, load balancers, etc.
Storage Module, which manages S3 buckets, EBS, RDS, etc.
Services Module, which includes managed databases, caches, and serverless components.

A non-limiting exemplary terraform script is presented below:
Main Configuration (main.tf): This file calls the individual modules, passing in necessary variables to provision the resources as a unified stack.
Variables (variables.tf): Defines all variables needed for the modules, such as region, environment (e.g., dev, staging, prod), instance sizes, etc.
Outputs (outputs.tf): Exposes necessary outputs from the modules, such as VPC IDs, public IPs, or load balancer endpoints, which other modules or resources might need.
Provider (provider.tf): Specifies the cloud provider and authentication details, ensuring the terraform script can connect and deploy resources to the target environment.

At step 702 the validated migration code is executed in accordance with the provisioned infrastructure.

At step 703 a dashboard is transmitted for display in a user interface, the dashboard indicating one or more metrics relating to a status of the migration. This step can include provisioning monitoring and observability tools such as Prometheus, Grafana, and Datadog. This step can also include generating standard dashboard templates that display key performance metrics, such as but not limited to, latency, throughput, memory usage, and health indicators, such as but not limited to, status checks and error monitoring, for your applications and infrastructure. This step can further include defining alerting rules based on thresholds (e.g., CPU usage >80%), anomalies, or specific conditions to trigger notifications for critical events. These alerts can include notifying an administrator via email, webhook notification, or other notification method. Additionally, this step can include transmitting recommendations for integrating automatically generated IaC scripts and reports from application code scans into the continuation integration/continuous delivery CI/CD pipeline. These recommendations can include, for example, optimizing indexing based on query patterns or adjusting instance sizes based on load, that can be reviewed and implemented by a user. After migration, the dashboard can continue to be used to monitor ongoing deployment, ensuring stability and performance.

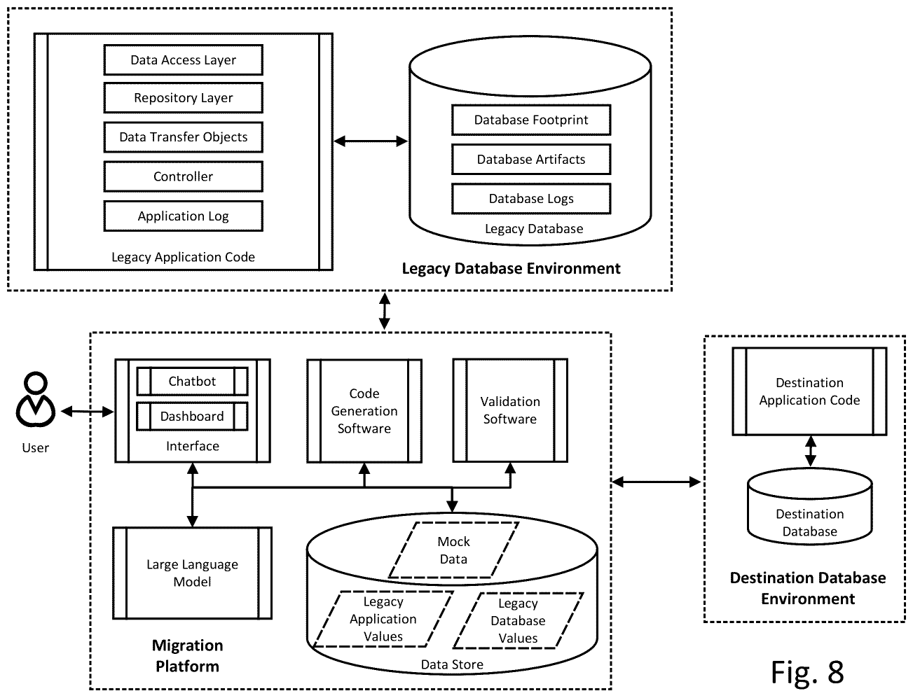

FIG. 8 illustrates a system diagram of the migration platform, a legacy database environment, and a destination database environment according to an exemplary embodiment.

As shown in FIG. 8, the legacy database environment can include a legacy database and legacy application code that interfaces with the legacy database. The legacy database can include structures corresponding to a database footprint, database artifacts, and database logs. The legacy application code can include a data access layer, repository layer, data transfer objects, a controller, and an application log.

The migration platform can include an interface, including interfaces for a chatbot and migration dashboard. The migration platform also includes code generation software that utilizes generative AI to generate migration code. The migration platform further includes a large language model used for legacy system analysis and code generation, validation software, and a data store or repository. The data store can be used to store, mock data, legacy application values, and legacy database values.

The destination database environment can include a destination database and destination application code that is configured to interface with the destination database. Although not shown in FIG. 8, the destination database environment can include corresponding structures to those shown in the legacy database environment. Additionally, the legacy database environment, migration platform, and the destination database environment can include any of the structures described above.

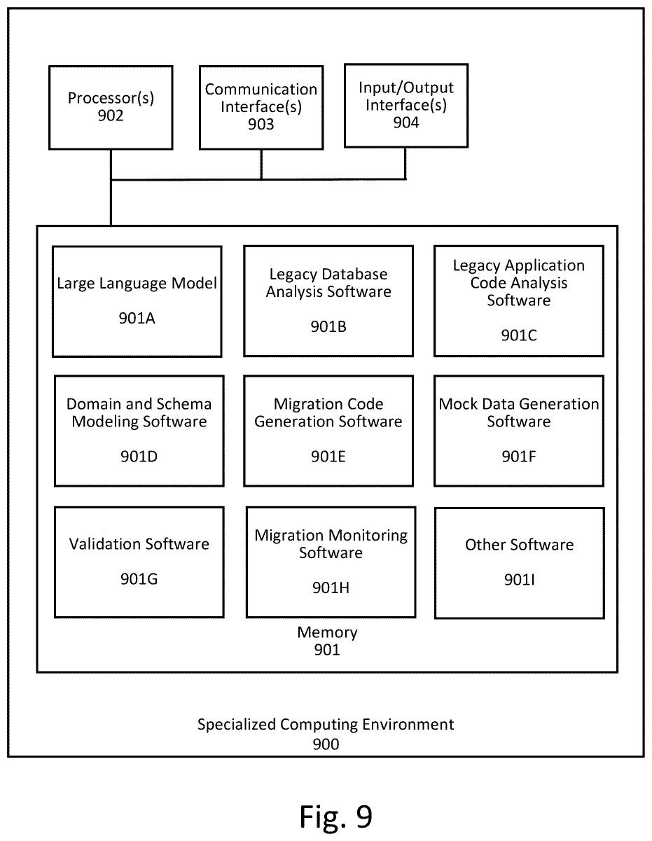

One or more of the above-described techniques can be implemented in or involve one or more special-purpose computer systems having computer-readable instructions loaded thereon that enable the computer system to implement the above-described techniques. FIG. 9 illustrates the specialized computing environment 900 of the migration platform that is used to perform the above-described methods and implement the above-described systems according to an exemplary embodiment.

With reference to FIG. 9, the computing environment 900 includes at least one processing unit/controller 902 and memory 901. The processing unit 902 executes computer-executable instructions. In a multi-processing system, multiple processing units execute computer-executable instructions to increase processing power. The memory 901 can be volatile memory (e.g., registers, cache, RAM), non-volatile memory (e.g., ROM, EEPROM, flash memory, etc.), or some combination of the two. The memory 901 can store software implementing the above-described techniques, including large language model 901A, legacy database analysis software 901B, legacy application code analysis software 901C, domain and schema modeling software 901D, migration code generation software 901E, mock data generation software 901F, validation software 901G, migration monitoring software 901H, and other software, such as the chatbot software, dashboard software, or any other software described herein.

All of the software stored within memory 901 can be stored as a computer-readable instructions, that when executed by one or more processors 902, cause the processors to perform the functionality described with respect to FIGS. 1-8.

Processor(s) 902 execute computer-executable instructions. In a multi-processing system, multiple processors or multicore processors can be used to execute computer-executable instructions to increase processing power and/or to execute certain software in parallel.

Specialized computing environment 900 additionally includes a communication interface 903, such as a network interface, which is used to communicate with devices, applications, or processes on a computer network or computing system, collect data from devices on a network, such as legacy systems, destination systems, or other network systems, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 900 further includes input and output interfaces 904 that allow users (such as system administrators) to provide input to the system to set parameters, to edit data stored in memory 901, or to perform other administrative functions.

An interconnection mechanism (shown as a solid line in FIG. 9), such as a bus, controller, or network interconnects the components of the specialized computing environment 900.

Input and output interfaces 904 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 900.

Specialized computing environment 900 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 900.

As discussed above, the present methods, systems, and computer-readable media of the migration platform provide many benefits. The disclosed Artificial Intelligence (AI) infused legacy application transformation system combines the power of Large Language Models (LLMs) and Generative AI (GenAI). This cutting-edge approach enables the seamless modernization of outdated applications, ensuring they are optimized for current technologies and platforms while significantly minimizing the time and effort required. The present solution utilizes a multi-faceted approach to application modernization with several components, such as:
Large Language Models (LLMs) to parse and understand the legacy code and database artifacts.
Generative AI to create new code and architectural elements.
Specialized algorithms configured to address unique challenges in application modernization, including identifying the most critical parts of the code to transform, determining the target domain model and others.
End-to-End Process Orchestration that takes the application from its legacy state through the transformation process to a modern platform without requiring extensive manual intervention.
Content-aware and specialized chunking algorithms implemented for different types of data including database code, services code, UI code and logs.
Generic Knowledge graph builder for legacy artifacts as well as extracted knowledge.
Easy access to analyzed information and knowledge graph using Vector search and custom prompt library.
Intelligent Domain model generation based on legacy schema model, layering in knowledge extracted from database artifacts and service code base.
Configurable Synthetic domain-specific data generator for validating target state schema model.
Code generation engine that utilizes a personalized prompt library for multiple programming languages, allowing users to incorporate language and framework specific elements as needed. This allows users to introduce customized constructs relevant to their best practices.
Quality Assurance in the generated code through the automatic creation of relevant test cases. This allows users to define their chosen test framework and programming language, ensuring comprehensive testing tailored to their specific preferences and criteria.
Functional validation of generated code by comparing results from legacy against the transformed application.
Performance validation of generated code by confirming the generated code fulfils the business functionality performed by the legacy application code.
Automated Observability framework generation based on user preference.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

We claim:

1. A method executed by one or more computing devices of a migration platform for legacy database migration with a large language model, the method comprising:
analyzing a legacy database based at least in part on applying a large language model to the legacy database to extract one or more legacy database values and applying the large language model to legacy application code that interfaces with the legacy database to extract one or more legacy application values;
determining a plurality of destination database values corresponding to a destination database based at least in part on the one or more legacy database values and the one or more legacy application values, the plurality of destination database values comprising one or more destination domains, one or more destination schemas, and one or more data mappings between the legacy database and the destination database;
generating migration code for migrating the legacy database to the destination database based at least in part on one or more code generation templates, one or more user preferences, and one or more code generation procedures configured to create one or more files and one or more directories based at least in part on the one or more code generation templates;
validating the migration code based at least in part on generating mock data, storing the mock data in the legacy database, and applying the migration code to the mock data to migrate the mock data to the destination database; and
executing the validated migration code to perform a migration of the legacy database to the destination database.

2. The method of claim 1, wherein applying a large language model to the legacy database to extract one or more legacy database values comprises:
analyzing a footprint of a legacy database to determine one or more database inventory values;
determining a data volume in the legacy database based at least in part on the one or more database inventory values;
analyzing one or more artifacts of the legacy database to extract one or more of: one or more stored logic values, one or more dependency values, or one or more interface values; and
analyzing one or more database logs of the legacy database to extract one or more of: one or more usage trend values, one or more frequent query values, and one or more database growth values.

3. The method of claim 1, wherein applying the large language model to legacy application code that interfaces with the legacy database to extract one or more legacy application values comprises:
analyzing one or more of a data access layer of the legacy application code, a repository layer of the legacy application code, at least one data transfer object of the legacy application code, or controller code of the legacy application code to extract one or more of: one or more inline queries, one or more database access patterns, one or more object-relational mappings, one or more mapping logic values, one or more data manipulation values, or one or more data transformation values;
analyzing one or more application logs of the legacy application code to extract one or more endpoint frequency values;
analyzing the legacy application code to determine one or more complexity values; and
vectorizing one or more application code artifacts to produce one or more vector embeddings.

4. The method of claim 1 wherein determining a plurality of destination database values corresponding to a destination database based at least in part on the one or more legacy database values and the one or more legacy application values comprises:
storing the one or more legacy database values and the one or more legacy application values in a data store;
executing a chatbot program that is integrated with the large language and model and configured to interface with the data store; and
determining one or more destination database values in the plurality of destination database values based at least in part on a plurality of user queries received by the chatbot program.

5. The method of claim 1, wherein determining one or more destination database values in the plurality of destination database values based at least in part on one or more user queries received by the chatbot program comprises:
determining a plurality of destination domains based at least in part on the one or more legacy database values and one or more user queries in the plurality of user queries;
determining a plurality of destination schemas based at least in part on the one or more legacy database values and one or more second user queries in the plurality of user queries; and
mapping a plurality of interfaces in the one or more legacy database values to the plurality of destination domains.

6. The method of claim 1, wherein generating migration code for migrating the legacy database to the destination database based at least in part on one or more code generation templates, one or more user preferences, and one or more code generation procedures configured to create one or more files and one or more directories based at least in part on the one or more code generation templates comprises:
receiving a selection of one or more programming languages and one or more frameworks from a user;
generating the one or more code generation templates based at least in part on the one or more programming languages and the one or more frameworks; and
generating the migration code based at least in part on the one or more code generation templates and the one or more code generation procedures.

7. The method of claim 6, wherein generating migration code for migrating the legacy database to the destination database based at least in part on one or more code generation templates, one or more user preferences, and one or more code generation procedures configured to create one or more files and one or more directories based at least in part on the one or more code generation templates further comprises:
generating one or more query templates based at least in part on one or more frequent query values in the one or more legacy database values;
receiving one or more inputs from the user to customize the one or more code generation templates; and
generating the migration code based at least in part on the customized one or more code generation templates, the one or more frameworks, and the one or more code generation procedures.

8. The method of claim 1, wherein validating the migration code based at least in part on generating mock data, storing the mock data in the legacy database, and applying the migration code to the mock data to migrate the mock data to the destination database comprises:
generating one or more mock data types based at least in part on at least one legacy database value in the one or more legacy database values;
generating a data generation profile based at least in part on one or more legacy query values in the one or more legacy database values;
generating one or more volumes of mock data based at least in part on the one or more mock data types and the data generation profile; and
migrating the one or more volumes of mock data to the destination database.

9. The method of claim 8, wherein validating the migration code based at least in part on generating mock data, storing the mock data in the legacy database, and applying the migration code to the mock data to migrate the mock data to the destination database further comprises:
validating one or more destination schemas based at least in part on one or more of: at least one legacy database value in the one or more legacy database values, one or load tests, or one or more scalability tests.

10. The method of claim 1, wherein executing the validated migration code to perform a migration of the legacy database to the destination database comprises:
provisioning an infrastructure of the destination database;
executing the validated migration code in accordance with the provisioned infrastructure; and
transmitting a dashboard for display in a user interface, the dashboard indicating one or more metrics relating to a status of the migration.

11. A system for legacy database migration with a large language model, the system comprising:
one or more processors; and
one or more memories operatively coupled to at least one of the one or more processors and having instructions stored thereon that, when executed by at least one of the one or more processors, cause at least one of the one or more processors to:
analyze a legacy database based at least in part on applying a large language model to the legacy database to extract one or more legacy database values and applying the large language model to legacy application code that interfaces with the legacy database to extract one or more legacy application values;
determine a plurality of destination database values corresponding to a destination database based at least in part on the one or more legacy database values and the one or more legacy application values, the plurality of destination database values comprising one or more destination domains, one or more destination schemas, and one or more data mappings between the legacy database and the destination database;
generate migration code for migrating the legacy database to the destination database based at least in part on one or more code generation templates, one or more user preferences, and one or more code generation procedures configured to create one or more files and one or more directories based at least in part on the one or more code generation templates;
validate the migration code based at least in part on generating mock data, store the mock data in the legacy database, and apply the migration code to the mock data to migrate the mock data to the destination database; and
execute the validated migration code to perform a migration of the legacy database to the destination database.

12. The system of claim 11, wherein the instructions that cause the at least one or more processors to apply a large language model to the legacy database to extract one or more legacy database values further cause at least one of the one or more processors to:
analyze a footprint of a legacy database to determine one or more database inventory values;
determine a data volume in the legacy database based at least in part on the one or more database inventory values;
analyze one or more artifacts of the legacy database to extract one or more of: one or more stored logic values, one or more dependency values, or one or more interface values; and
analyze one or more database logs of the legacy database to extract one or more of: one or more usage trend values, one or more frequent query values, and one or more database growth values.

13. The system of claim 11, wherein the instructions that cause the at least one or more processors to apply a large language model to legacy application code that interfaces with the legacy database to extract one or more legacy application values further cause at least one of the one or more processors to:
analyze one or more of a data access layer of the legacy application code, a repository layer of the legacy application code, at least one data transfer object of the legacy application code, or controller code of the legacy application code to extract one or more of: one or more inline queries, one or more database access patterns, one or more object-relational mappings, one or more mapping logic values, one or more data manipulation values, or one or more data transformation values;
analyze one or more application logs of the legacy application code to extract one or more endpoint frequency values;
analyze the legacy application code to determine one or more complexity values; and
vectorize one or more application code artifacts to produce one or more vector embeddings.

14. The system of claim 11, wherein the instructions that cause the at least one or more processors to determine a plurality of destination database values corresponding to a destination database based at least in part on the one or more legacy database values and the one or more legacy application values further cause at least one of the one or more processors to:
store the one or more legacy database values and the one or more legacy application values in a data store;
execute a chatbot program that is integrated with the large language and model and configured to interface with the data store; and
determine one or more destination database values in the plurality of destination database values based at least in part on a plurality of user queries received by the chatbot program.

15. The system of claim 11, wherein the instructions that cause the at least one or more processors to determine one or more destination database values in the plurality of destination database values based at least in part on one or more user queries received by the chatbot program further cause at least one of the one or more processors to:
determine a plurality of destination domains based at least in part on the one or more legacy database values and one or more user queries in the plurality of user queries;
determine a plurality of destination schemas based at least in part on the one or more legacy database values and one or more second user queries in the plurality of user queries; and
map a plurality of interfaces in the one or more legacy database values to the plurality of destination domains.

16. One or more non-transitory computer-readable medium storing computer-readable instructions for legacy database migration with a large language model that, when executed by one or more computing devices of an executor, cause at least one of the one or more computing devices to:
analyze a legacy database based at least in part on applying a large language model to the legacy database to extract one or more legacy database values and applying the large language model to legacy application code that interfaces with the legacy database to extract one or more legacy application values;
determine a plurality of destination database values corresponding to a destination database based at least in part on the one or more legacy database values and the one or more legacy application values, the plurality of destination database values comprising one or more destination domains, one or more destination schemas, and one or more data mappings between the legacy database and the destination database;
generate migration code for migrating the legacy database to the destination database based at least in part on one or more code generation templates, one or more user preferences, and one or more code generation procedures configured to create one or more files and one or more directories based at least in part on the one or more code generation templates;
validate the migration code based at least in part on generating mock data, store the mock data in the legacy database, and apply the migration code to the mock data to migrate the mock data to the destination database; and
execute the validated migration code to perform a migration of the legacy database to the destination database.

17. The one or more non-transitory computer-readable medium of claim 16, wherein the instructions that cause at least one of the one or more computing devices to generate migration code for migrating the legacy database to the destination database based at least in part on one or more code generation templates, one or more user preferences, and one or more code generation procedures configured to create one or more files and one or more directories based at least in part on the one or more code generation templates further cause at least one of the one or more computing devices to:
receive a selection of one or more programming languages and one or more frameworks from a user;
generate the one or more code generation templates based at least in part on the one or more programming languages and the one or more frameworks; and
generate the migration code based at least in part on the one or more code generation templates and the one or more code generation procedures.

18. The one or more non-transitory computer-readable medium of claim 17, wherein the instructions that cause at least one of the one or more computing devices to generate migration code for migrating the legacy database to the destination database based at least in part on one or more code generation templates, one or more user preferences, and one or more code generation procedures configured to create one or more files and one or more directories based at least in part on the one or more code generation templates further cause at least one of the one or more computing devices to:
generate one or more query templates based at least in part on one or more frequent query values in the one or more legacy database values;
receive one or more inputs from the user to customize the one or more code generation templates; and
generate the migration code based at least in part on the customized one or more code generation templates, the one or more frameworks, and the one or more code generation procedures.

19. The one or more non-transitory computer-readable medium of claim 16, wherein the instructions that cause at least one of the one or more computing devices to validate the migration code based at least in part on generating mock data, storing the mock data in the legacy database, and applying the migration code to the mock data to migrate the mock data to the destination database further cause at least one of the one or more computing devices to:
generate one or more mock data types based at least in part on at least one legacy database value in the one or more legacy database values;
generate a data generation profile based at least in part on one or more legacy query values in the one or more legacy database values;
generate one or more volumes of mock data based at least in part on the one or more mock data types and the data generation profile;
migrate the one or more volumes of mock data to the destination database; and
validate one or more destination schemas based at least in part on one or more of: at least one legacy database value in the one or more legacy database values, one or load tests, or one or more scalability tests.

20. The one or more non-transitory computer-readable medium of claim 16, wherein the instructions that cause at least one of the one or more computing devices to execute the validated migration code to perform a migration of the legacy database to the destination database further cause at least one of the one or more computing devices to:
provision an infrastructure of the destination database;
execute the validated migration code in accordance with the provisioned infrastructure; and
transmit a dashboard for display in a user interface, the dashboard indicating one or more metrics relating to a status of the migration.
